(19) United States
(12) Patent Application Publication
(10) Pub. No.: US 2026/0319699 A1
(43) Pub. Date: Oct. 15, 2026

(54) METHOD FOR CONTROLLING BUFFER MEMORY AND VEHICLE USING SAME

(71) Applicants: HYUNDAI MOTOR COMPANY, Seoul (KR); KIA CORPORATION, Seoul (KR)

(72) Inventor: Yu Ho CHOI, Hwaseong-si (KR)

(21) Appl. No.: 19/647,027

(22) Filed: Apr. 14, 2026

(30) Foreign Application Priority Data
Apr. 14, 2025 (KR) 10-2025-0047939

(51) Int. Cl. G06F 3/06; G06F 9/48

(52) U.S. Cl. CPC G06F 3/0656; G06F 3/0604; G06F 3/0679; G06F 9/4806

(57) ABSTRACT

Disclosed herein a method for controlling buffer memory and vehicle using same. The method includes: aligning, based on a size of a plurality of preceding data generated by processing of the first processor on a plurality of sensor data in which a surrounding environment is detected, the plurality of preceding data; storing, based on a capacity of the buffer memory, the plurality of preceding data in an alignment order in the buffer memory; performing, by the second processor, task processing on the preceding data stored in the buffer memory in the alignment order to generate task data; storing, based on the incomplete processing of all of the plurality of preceding data, the task data in the system memory; and generating, by the first processor, based on the complete processing on all of the plurality of preceding data, following data based on the task data.

### CROSS-REFERENCE TO RELATED APPLICATION

This application claims the benefit of priority to Korean Patent Application No. 10-2025-0047939, filed in the Korean Intellectual Property Office on Apr. 14, 2025, the disclosure of which is incorporated herein by reference in its entirety.

### TECHNICAL FIELD

The present disclosure relates to a method for controlling a buffer memory, and a vehicle using the same, and more specifically, to a method for managing a buffer memory and a vehicle that improve resource efficiency and processing rate by dynamic memory management using system cache.

### BACKGROUND

The matters described in this Background section are only for enhancement of understanding of the background of the disclosure, and should not be taken as acknowledgment that they correspond to prior art already known to those skilled in the art.

An autonomous driving function may be configured to estimate a path and control the vehicle through recognition of the surrounding environment. A complexity of a learned model is increasing to meet the high level of perception performance required by autonomous driving.

To process the learning model at high speed, a system on chip (SoC) equipped with a neural network processor may be used. The neural network processor may be designed for common operations that are primarily used in the learning model, so that bottleneck phenomenon may occur when processing special operations included in a particular model. To complement this, a software pipelining technique may be applied utilizing various resources within the SoC. Nevertheless, software pipelining may incur performance losses due to data sharing between multiple resources from a system perspective.

### SUMMARY

The various examples of the present disclosure are to provide a method for managing a buffer memory and a vehicle that improve resource efficiency and processing rate by dynamic memory management using system cache.

The various examples to be achieved in the present disclosure are not limited to the above-mentioned technical problems, and other technical problems not mentioned will be clearly understood by a person skilled in the art from the following description.

According to the present disclosure, a method performed by a vehicle may comprise obtaining, via a sensor of the vehicle, sensor data associated with a surrounding environment of the vehicle, storing the sensor data into a system memory of the vehicle, generating preceding data based on the sensor data, sorting portions of the preceding data based on sizes of respective portions of the preceding data, storing the portions of the preceding data in an order of the sorted portions in a buffer memory based on a capacity of the buffer memory, where the buffer memory has a higher access speed and a smaller storage capacity than the system memory, performing task processing on the portions stored in the buffer memory in the order of the sorted portions to generate task data, storing the task data in the system memory based on incomplete processing of all the portions, generating control data based on the task data and complete processing of all the portions, outputting a control command based on the control data, and controlling a control operation of the vehicle based on the control command.

According to the present disclosure, a vehicle may comprise a sensor configured to obtain sensor data indicating a surrounding environment of the vehicle, a main memory configured to store the sensor data, a local memory configured to provide a higher access speed and a smaller storage capacity than the main memory, and a processor circuit configured to determine a path of the vehicle based on the sensor data, select from the sensor data sensor data associated with the path, perform a first stage processing on the selected sensor data to generate preceding data and store the preceding data in the main memory, sort portions of the preceding data based on sizes of respective portions of the preceding data, store a portion of the sorted portions into the local memory based on a capacity of the local memory, perform a second stage processing on the portion stored in the local memory, determine during the second stage processing whether additional portions of the preceding data remain in the main memory, load additional portions from the main memory into the local memory in an order of the sorted portions based on additional portions remaining in the main memory, perform a third stage processing on task data generated by the second stage processing to generate control data, output a signal associated with the control data, and control autonomous driving of the vehicle based on the signal.

The vehicle may include that the portions of the preceding data are sorted in descending order of sizes of respective portions of the preceding data. The vehicle may include that during sorting of the portions of the preceding data, the processor circuit assigns a first task identifier to a first portion of the portions of the preceding data and that after the second stage processing on the first portion is completed, the processor circuit deletes the first task identifier assigned to the first portion. The vehicle may include that the processor circuit and the local memory are provided within a System on Chip and that the main memory may comprise a volatile memory.

According to the present disclosure, a vehicle may comprise a plurality of sensors configured to obtain sensor data associated with a surrounding environment of the vehicle, a system memory configured to store the sensor data, a buffer memory configured to have a higher access speed and a smaller storage capacity than the system memory, and a processor, wherein the system memory stores at least one instruction that when executed by the processor is configured to generate preceding data based on the sensor data, sort portions of the preceding data based on sizes of respective portions of the preceding data, store the portions of the preceding data in an order of the sorted portions in the buffer memory based on a capacity of the buffer memory, perform task processing on the portions stored in the buffer memory in the order of the sorted portions to generate task data, store the task data in the system memory based on incomplete processing of all the portions, generate control data based on the task data and complete processing of all the portions, output a control command based on the control data, and control a control operation of the vehicle based on the control command.

The vehicle may include that the generation of the preceding data and the generation of the control data are performed by a neural processing device and that the task processing is performed by at least one of a central processing unit, a graphics processing unit, or a digital signal processor. The vehicle may include that the portions of the preceding data are generated in the system memory before being sorted and stored in the buffer memory. The vehicle may include that the order of the sorted portions is determined in descending order of sizes of respective portions. The vehicle may include that during storing of the portions of the preceding data in the buffer memory at least a portion of the portions of the preceding data is stored in the order in the buffer memory to match a capacity of the buffer memory and that during performing of the task processing additional portions of the preceding data are stored in the order in the buffer memory based on presence of the additional portions of the preceding data.

The vehicle may include that during sorting of the portions of the preceding data a task identifier is assigned to each portion of the preceding data. The vehicle may include that after task processing on a portion of the preceding data is completed a task identifier assigned to the portion is deleted. The vehicle may include instructions that when executed by the processor are configured to select, based on prior sensor data, pieces of sensor data from among a plurality of pieces of sensor data, where the selected pieces of sensor data correspond to an estimated path of the vehicle, and generate the preceding data based on the selected pieces of sensor data. The vehicle may include instructions that when executed by the processor are configured to execute, based on the sensor data, at least one layer of a neural network based learning model to generate the preceding data. The vehicle may include that the processor and the buffer memory are provided within a System on Chip and that the system memory may comprise a volatile memory.

The features briefly summarized above for this disclosure are only examples of the detailed description of the disclosure which follow and are not intended to limit the scope of the disclosure.

### BRIEF DESCRIPTION OF THE DRAWINGS

The above and other objects, features and advantages of the present disclosure will become more apparent to those of ordinary skill in the art by describing one or more example examples thereof in detail with reference to the accompanying drawings, in which:

FIG. 1 shows an example of a vehicle communicating with another device to transmit and receive data.

FIG. 2 shows an example of modules that configure a vehicle.

FIG. 3 shows an example of modules that configure a controller and a system memory.

FIG. 4 shows an example of a memory map of a system memory.

FIG. 5 shows an example of modules that configure a server.

FIG. 6A and FIG. 6B are exemplary flowcharts of a method for controlling a buffer memory.

FIG. 7 shows an example of sensor data obtained by a plurality of sensors.

FIG. 8 shows an example of a specification of task processing in a second processor.

FIG. 9 shows an example of data processing according to a combination of a buffer memory and a system memory and the use of the system memory alone.

FIG. 10 shows an example computing system.

### DETAILED DESCRIPTION

Hereinafter, examples of the present disclosure will be described in detail with reference to the accompanying drawings so that those skilled in the art may easily implement the present disclosure. However, the present disclosure may be implemented in various ways and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all combinations of the listed items. For example, "at least one of A or B" may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous-driving settings (e.g., a selected autonomous-driving level or a classification of driving mode). Based on the feature of adaptive buffer-assisted prioritized sensor-data processing described herein, the vehicle may control various autonomous-driving operations more responsively (e.g., updating lane-keeping control when high-priority front-camera data is processed first, adjusting braking control when large radar feature blocks are prioritized, or refining steering timing when additional sensor data is dynamically loaded into the buffer). The vehicle control may include operational controls associated with the vehicle (e.g., autonomous-driving control, sensor control, braking timing control, acceleration adjustment, alarm timing control, or forward-collision warning time control).

One or more auxiliary devices (e.g., engine brake, exhaust brake, hydraulic retarder, electric retarder, regenerative brake, etc.) may also be controlled based on the feature of adaptive buffer-assisted prioritized sensor-data processing. For example, when high-priority downhill-grade sensor data is processed first, the vehicle may activate an engine brake earlier; when radar-based distance features are dynamically loaded into the buffer, a hydraulic retarder may be adjusted to maintain safe spacing; and when front-camera features indicate rapid deceleration ahead, a regenerative brake may be increased to assist energy recovery.

One or more communication devices (e.g., a modem, network adapter, radio transceiver, or antenna supporting Ethernet, Wi-Fi, NFC, Bluetooth, LTE, 5G NR, or V2X) may also be controlled based on the feature of adaptive buffer-assisted prioritized sensor-data processing. For example, when high-priority hazard-related sensor data is processed first, a V2X transmitter may immediately broadcast a warning; when buffered multi-camera features indicate congestion, a 5G modem may prioritize uplink telemetry; and when dynamically loaded radar features reveal a lane-change event, a Wi-Fi or Bluetooth module may adjust bandwidth allocation for in-vehicle devices.

Minimum risk maneuver (MRM) operations may also be controlled based on the feature of adaptive buffer-assisted prioritized sensor-data processing. For example, when high-priority front-camera or radar features indicating sudden obstacles are processed first, the vehicle may initiate an immediate slow-down MRM; when dynamically loaded sensor data reveals loss of lane boundary information, the vehicle may steer toward a safe shoulder; and when prioritized perception data indicates the driver is unresponsive, the processors may maintain controlled braking for a set period to bring the vehicle to a minimum-risk state. A minimal risk maneuver may be activated during autonomous driving when the driver fails to respond to an intervention request, and one or more processors may control vehicle motion to achieve a lowered risk condition.

Biased driving operation(s) may also be controlled based on the feature of adaptive buffer-assisted prioritized sensor-data processing. For example, when high-priority side-camera or radar features are processed first, the driving control apparatus may bias the vehicle toward the lane side with fewer obstacles; when dynamically loaded sensor data indicates a large truck in an adjacent lane, the system may increase the lateral offset for additional clearance; and when prioritized front-camera data reveals uneven road edges, the apparatus may adjust the biased target lateral distance to maintain stability. A biased driving control may intentionally maintain a lateral distance different from the lane center to improve safety or performance under varying conditions, such as lane changes, obstacle avoidance, or proximity to other vehicles.

One or more sensors (e.g., IMU sensors, cameras, LiDAR, RADAR, blind-spot sensors, lane-departure sensors, parking sensors, light or rain sensors, traction or stability sensors, tire-pressure sensors, or airbag sensors) may also be controlled based on the feature of adaptive buffer-assisted prioritized sensor-data processing. For example, when high-priority front-camera features are processed first, the system may increase the frame rate of the front camera; when dynamically loaded radar features reveal fast-approaching objects, the radar may switch to a higher-resolution mode; and when prioritized IMU data indicates instability, additional sensors such as traction or stability sensors may be activated to refine perception. Such sensor control may support autonomous-driving operations including acceleration, deceleration, steering, braking, lane keeping, collision avoidance, and other driving-control functions.

An autonomous driving level and/or autonomous-driving activation or deactivation may also be controlled based on the feature of adaptive buffer-assisted prioritized sensor-data processing. For example, when prioritized sensor features indicate complex road geometry or dense traffic, the system may automatically raise the autonomous-driving level to require increased driver attentiveness; when dynamically loaded camera and radar features reveal driver inattention or an unsafe environment, autonomous driving may be temporarily deactivated; and when high-priority sensor data confirms stable conditions, the system may maintain or resume a higher autonomous-driving mode. Adjustments may include increasing the required frequency of hands-on-wheel or eyes-forward checks or restricting display of video content during higher autonomy levels.

According to the present disclosure, a vehicle may manage large amounts of sensor data more efficiently by using a buffer memory system that prioritizes and organizes data before it is processed. Modern vehicles equipped with autonomous driving functions receive continuous streams of images, radar signals, and other sensor inputs, and these data streams may exceed the processing speed of the vehicle’s various internal processors. The present disclosure describes dynamically selecting only the sensor data relevant to the vehicle’s estimated path, arranging the selected data by size, and temporarily storing the higher-priority data in a high-speed buffer cache. As each portion of data is processed, the buffer memory supplies the next portion in the proper order, reducing delays that occur when processors repeatedly access slower system memory. By controlling data flow in this manner, the vehicle may reduce unnecessary processing, improve overall responsiveness, and support more reliable autonomous driving behavior.

Hereinafter, examples of the present disclosure will be described with reference to the accompanying drawings.

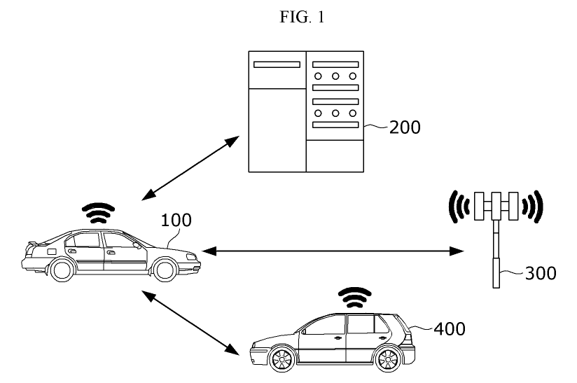

Hereinafter, a vehicle that dynamically manages a buffer memory mounted on a controller that performs processing related to control of the vehicle and processes data read from the buffer memory in a processor will be described with reference to FIGS. 1 to 4.

FIG. 1 shows an example of a vehicle communicating with another device to transmit and receive data.

Referring to FIG. 1, a vehicle 100 may be driven on an electric energy or fossil energy basis. In the case of electric energy, the vehicle 100 may employ, for example, a pure battery-based vehicle driven only by a high-voltage battery or a gas-based fuel cell as an energy source. In addition, the fuel cell may utilize various forms of gas capable of generating electrical energy, and the gas may be filled into the vehicle 100, for example, in a liquefied state. Here, the gas may be, for example, hydrogen (e.g., compressed hydrogen, liquid hydrogen, ammonia-based hydrogen carriers, or reformable hydrocarbons, etc.). However, various gases are applicable without being limited thereto. In the case of fossil energy, the vehicle 100 may be driven based on a fuel, such as gasoline, diesel, or liquefied gas, and may be equipped with an internal combustion engine that drives an actuator 114 by combustion of the fuel. The engine may be included in a power source portion 112 in terms of providing a driving rotational force of a wheel. As another example, the vehicle 100 may selectively utilize the energy of a fossil energy-based internal combustion engine and an electric battery to drive the actuator 114, which may be a hybrid type of vehicle (e.g., HEV, PHEV, or mild-hybrid configurations, etc.).

The vehicle 100 may refer to a device capable of moving. The vehicle 100 is a ground vehicle driving on the ground, and may be a conventional passenger or commercial vehicle, a Purpose-Built Vehicle (PBV), or the like. The vehicle 100 may be a four-wheeled vehicle, such as a passenger car, an SUV, a small truck, or may be a vehicle with more than four wheels, such as a bus, a large truck, a container transport vehicle, a heavy-equipment vehicle, or the like (e.g., a mining hauler, airport shuttle, or warehouse logistics carrier, etc.). The vehicle 100 may be a robot in a broad sense, such as a moving means, and the robot may be moved using wheels, tracks, or other moving modules (e.g., articulated tracks, omnidirectional wheels, or robotic leg assemblies, etc.).

The vehicle 100 may be controlled and driven by manual driving or autonomous driving due to the driving of a user. The autonomous driving may be implemented as semi-autonomous driving or fully autonomous driving. The fully autonomous driving may be provided with autonomous movement in which a controller 118 of the vehicle 100 fully controls without user intervention, even if the driving situation is uncertain. The semi-autonomous driving may be provided in an autonomous movement in which driver intervention is required according to a specific driving situation (e.g., low-visibility conditions, complex intersections, or emergency avoidance maneuvers, etc.). The semi-autonomous driving may be implemented such that the controller 118 switches control to the user while deactivating autonomous driving upon the occurrence of the situation, thereby causing the user to perform manual driving. According to the level of autonomous driving defined by the American Society of Automotive Engineers SAE, the semi-autonomous driving corresponds to autonomous driving levels 1 to 4, and the fully autonomous driving may correspond to level 5.

On the other hand, the vehicle 100 may communicate with other devices 200, 300 or another vehicle 400. Other devices may include, for example, a server 200 that supports various controls, state management, and driving of the vehicle 100, an ITS device 300 that receives information from an intelligent transportation system (ITS), various types of user devices, and the like (e.g., smartphones, tablets, or wearable devices, etc.). The server 200 is, for example, an external device operated by a vehicle manufacturer or provided to service a driving support function and may receive connected data of the vehicle 100 or transmit data necessary for manual and autonomous driving. The server 200 may transmit various information and software modules used for control of the vehicle 100 to the vehicle 100 in response to requests and data transmitted from the vehicle 100 and a user device, to support driving of the vehicle 100 and various services (e.g., map updates, over-the-air diagnostics, or software feature activations, etc.).

The ITS device 300 is, for example, a roadside base station (RSU), and the ITS device 300 may interchange vehicle recognition data, driving control and state data, environment data around the vehicle, map data, and the like through V2I with the vehicle 100 to assist the user's driving of the vehicle or support autonomous driving of the vehicle 100 (e.g., traffic-signal status, road-hazard alerts, or congestion data, etc.). The vehicle 100 may support manual driving or autonomous driving by interchanging the above-listed data through V2V with the other vehicle 400 (e.g., cooperative lane-merge data, blind-spot alerts, or platooning information, etc.).

The vehicle 100 may communicate with other vehicles or other devices based on cellular communication, Wireless Access in Vehicular Environment (WAVE) communication, Dedicated Short Range Communication (DSRC) or near field communication, or other communication schemes (e.g., UWB, Bluetooth, or infrared links, etc.).

For example, the vehicle 100 may use a communication network such as LTE or 5G, a WiFi communication network, a WAVE communication network, or the like as a cellular communication network for communication with the server 200, the ITS device 300, or the other vehicle 400. As another example, a DSRC or the like used in the vehicle 100 may be used for communication between vehicles (e.g., low-latency collision-avoidance messaging, cooperative braking signals, or local hazard broadcasting, etc.). A communication manner between the vehicle 100, the server 200, the ITS device 300, another vehicle 400, and a user device is not limited to the foregoing example.

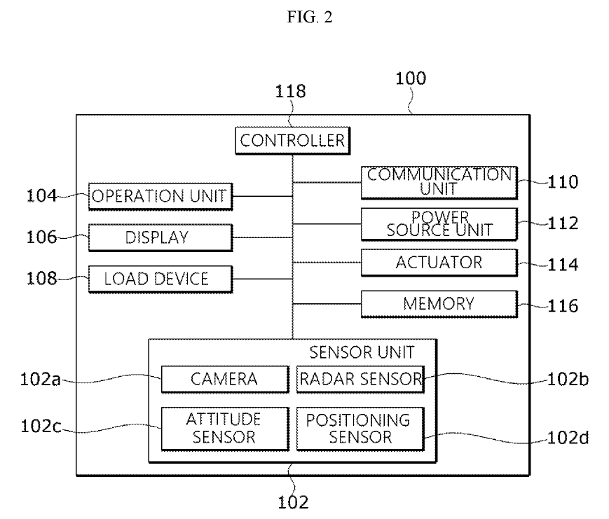

FIG. 2 shows an example of modules that configures a vehicle according to an example of the present disclosure.

The vehicle 100 may include a sensor unit 102, an operation unit 104, a display 106, a load device 108, and a communication unit 110.

The sensor unit 102 may include various types of sensors for sensing various states and situations occurring in an external surrounding environment, an internal system, a user operation, and a boarding space of the vehicle 100 (e.g., cabin-temperature changes, steering inputs, or passenger-presence conditions, etc.).

Specifically, the sensor unit 102 may include an externally oriented camera 102a, a radar sensor 102b, and the like to recognize dynamic and static objects existing in the periphery of the vehicle 100.

The camera 102a may recognize an external object as an image during use of the vehicle 100, generate image data, and transmit the image data to the controller 118. The at least one camera 102a may be mounted at a specific site of the vehicle 100, such as a front site, a rear site, a lateral site of the vehicle100 (e.g., grille-mounted, roof-mounted, or mirror-mounted positions, etc.). When a plurality of cameras 102a are mounted on each site, it may be referred to as a multi-camera in the present disclosure. The image data obtained by the plurality of cameras 102a may be referred to as multi-view image data. Although not shown, the sensor unit 102 may further include a camera directed toward the interior of the vehicle 100 (e.g., driver-monitoring camera, cabin-occupant camera, or gesture-recognition camera, etc.).

The radar sensor 102b may emit radio waves of a specific frequency around the vehicle 100 to generate radar data through the radio waves reflected from an external object in order to understand the presence and relative distance, velocity, and direction, etc. of the external object (e.g., approaching vehicles, roadside obstacles, or pedestrians, etc.). In the present disclosure, the radar sensor 102b recognizes an object in a manner different from that of the camera 102a and thus may be a type of heterogeneous sensor different from the camera 102a.

In the present disclosure, it is illustrated that a lidar sensor (not shown) is not mounted, but in another example, the lidar sensor may be mounted on the vehicle 100. The lidar sensor may generate and transmit point cloud data as recognized data of the external object to the processor to generate three-dimensional spatial information identifying at least a shape of an external object (e.g., vehicle contours, roadside structures, or road-surface irregularities, etc.). The lidar sensor may be a type of heterogeneous sensor different from the camera 102a.

The sensor unit 102 may include an attitude sensor 102c. The attitude sensor 102c may detect, for example, three-axis states of the vehicle 100, such as yaw, pitch, and roll, and output various pose states of the vehicle based on the factors described above. The attitude sensor may be configured, for example, as an IMU sensor, a gyro sensor, or the like (e.g., a six-axis IMU, a MEMS-based gyro, or a combined accelerometer-gyro sensor, etc.). The controller 118 may generate pose data based on the pose state.

In addition, the sensor unit 102 may include a positioning sensor 102d for confirming the position of the vehicle 100. The positioning sensor 102d is, for example, but not limited to, a GPS sensor or a GNSS sensor (e.g., GLONASS, Galileo, or BeiDou receivers, etc.).

In addition, although not shown in FIG. 1, the sensor unit 102 may include a brake sensor and a wheel sensor. The brake sensor detects a braking degree of the brake, and the wheel sensor may detect, for example, a wheel speed, a wheel rotation angle, and a wheel rotation angular speed of the wheel (e.g., via a Hall-effect sensor, magnetoresistive encoder, or optical encoder, etc.). The present disclosure mainly describes the sensors of the sensor unit 102 referred to in the description of the example and may further include sensors that sense various situations not listed therein (e.g., rain sensors, temperature sensors, or ultrasonic parking sensors, etc.).

The operation unit 104 may be configured as a module for a user to steer for driving. For example, the operation unit 104 may be a steering wheel for manual driving, an automatic or manual transmission actuator, an accelerator pedal, a brake pedal, a gear transmission, or the like. The operation unit 104 may further include an interface for using, releasing, and selecting a detailed function of the autonomous driving mode requested from the user, so that the user uses the autonomous driving function. The operation unit 104 may be configured with, for example, a hard type of interface provided at a predetermined position inside the vehicle 100, or a soft type interface that is touchable on the display 106, in order to receive various requests related to autonomous driving (e.g., lane-change requests, parking-assist activation, or driver-monitoring acknowledgments, etc.).

The display 106 may function as a user interface. The display 106 may be displayed by the controller 118 to output an operation state of the vehicle 100, a control state, path/traffic information, remaining energy information, content requested by the driver, and the like (e.g., navigation maps, multimedia playback, or charging-station information, etc.). In addition, the display 106 may be configured with a touch screen on which driver input is detectable to receive a driver's request instructing the controller 118.

The communication unit 110 may support mutual communication with the server 200, the ITS device 300, the surrounding vehicle 400 and the like. The communication unit 110 may include, for example, a module that processes cellular communication, WAVE, DSRC communication, and the like. In the present disclosure, a transmission/reception unit 116 may transmit data generated or stored during driving to the server 200 in a signal form and receive data and a software module transmitted from the server 200 as a specific type of signal (e.g., OTA updates, firmware patches, or remote-diagnosis messages, etc.).

The communication unit 110 may support communication for transmitting or receiving signals related to data, control, commands, and requests between the components of FIG. 2. The component may be an instrument or module referred to as 102-118 illustrated in FIG. 2. The communication unit 110 may transmit a signal transmitted between components, that is, a signal related to data, control, command, and request, to a communication bus by using, for example, controller area network (CAN) communication, and transmit the signal to a specific component. Data, controls, commands, and requests transmitted via CAN communication may be referred to as CAN data (e.g., sensor-status frames, actuator-control signals, or diagnostic requests, etc.).

The communication unit 110 may support communication with an electronic device carried by a passenger inside the vehicle 100 (e.g., smartphone pairing, media streaming, or wireless key access, etc.). In the present disclosure, the vehicle 100 may transmit and receive data utilized in the method according to the present disclosure to and from the outside through the communication unit 110.

In addition, the vehicle 100 may include the power source unit 112 and the actuator 114.

The power source unit 112 may generate and supply power and electric power to be used for a driving power system and a non-driving power system such as the actuator 114. The non-driving power system may be, for example, but not limited to, the sensor unit 102, the operation unit 104, the display 106, the load device 108, the communication unit 110, and the like, and may include various components that implement sensing, interface, communication, and convenience functions except for components directly involved in driving operations (e.g., HVAC systems, infotainment units, or interior-lighting controllers, etc.).

When the vehicle 100 is driven on an electrical energy basis, the power source unit 112 may be configured with, for example, an electrical battery charged from the outside or may be configured with a combination of an electrical battery and a fuel cell for charging the battery (e.g., PEM fuel cell, SOFC, or metal-hydride fuel system, etc.). In the case of a combination of an electric battery and a fuel cell, the power source unit 112 may include a tank that stores a material used to generate power of the fuel cell, such as liquefied hydrogen. When the vehicle 100 is driven on a fossil energy basis, the power source unit 112 may be configured as an internal combustion engine. In addition, when the vehicle 100 is of a hybrid type, the power source unit 112 may be provided by a combination of an internal combustion engine and an electric battery (e.g., series-hybrid, parallel-hybrid, or power-split hybrid configurations, etc.).

The actuator 114 includes at least one module that implements a driving operation and may execute the driving operation based on a signal according to a user request from the operation unit 104 or a request of the controller 118. The signal according to the request may be associated with at least one of a longitudinal control such as acceleration or deceleration, a lateral control such as steering, or a gear shift, for example (e.g., upshift, downshift, or mode selection, etc.). Here, the gear shift may be handled by the request of a manual driving user using a gear shifter or by the controller 118 in autonomous driving.

The actuator 114 may include a wheel drive unit, a mechanical component, and an electronic module for implementing a driving operation in the wheel drive unit, to perform a driving operation according to a command of the controller 118 by a user's manual operation or autonomous driving. When the vehicle 100 is operated on an electrical energy basis, it may include an assembly for transmitting the requested driving operation to the wheel drive unit (e.g., motor inverter, reduction gear, or e-axle assembly, etc.). When the vehicle 100 is operated on a fossil energy basis, the actuator 114 may include a transmission, gear module that transmits the power of the internal combustion engine.

The wheel drive unit may include a plurality of wheels, a driving force generation module for generating a driving force and applying or transmitting the driving force to the wheels, a braking module for decelerating driving of the wheels, and a steering module for realizing lateral control of the wheels (e.g., rack-and-pinion steering, steer-by-wire, or four-wheel steering, etc.). When the vehicle 100 is driven on an electrical energy basis, the driving force generation module may be configured with a motor assembly that generates a driving force on the basis of power output from an electrical battery. When the vehicle 100 is driven on a fossil energy basis, the driving force generation module may be an engine or a transmission assembly. The braking module of the electric-based vehicle 100 may further have a regenerative braking function (e.g., blended braking, coasting regeneration, or one-pedal driving, etc.).

In addition, the vehicle 100 may include a memory 116 and the controller 118.

The memory 116 may store applications and various data for control of the vehicle 100 and load the applications or read and write data at the request of the controller 118. The application may be executed by the controller 118 using at least one controller that performs a particular function (e.g., perception processing, path planning, or system diagnostics, etc.).

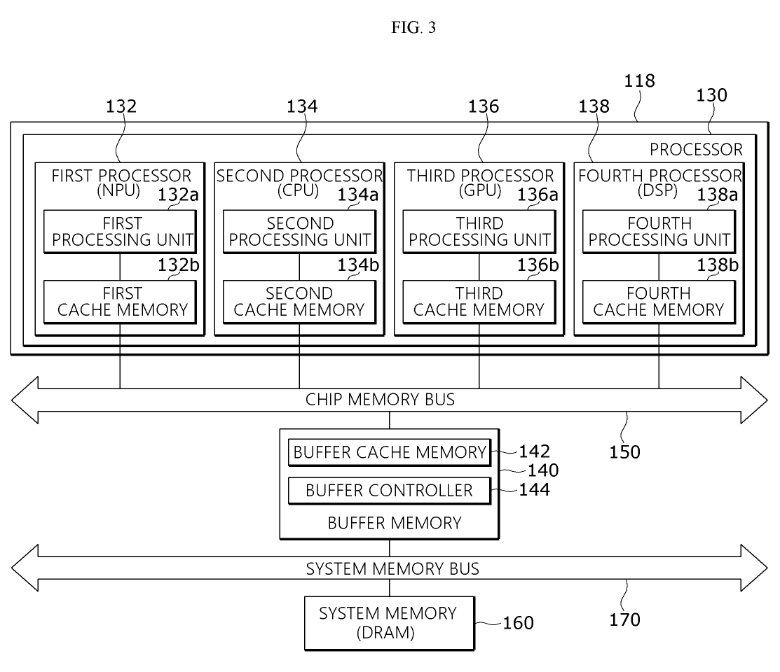

In the present disclosure, the memory 116 may include a volatile memory and a non-volatile memory. The volatile memory may be a system memory 160 including DRAM, as illustrated in FIG. 3. FIG. 3 shows an example of modules that configure a controller and a system memory. The system memory 160 may include a storage that temporarily stores data and a memory controller that controls/manages the storage (e.g., read scheduling, refresh operations, or address mapping, etc.). The non-volatile memory may be, for example, ROM, flash memory, or the like. The system memory 160 may store data processed or completed by the processor 130 of the controller 118. The system memory 160 may also store applications used by the controller 118. The system memory 160 may communicate data with the controller 118 using a system memory bus 170.

The non-volatile memory may hold an application that performs processing of a plurality of sensor data detected by the sensor unit 102, dynamic management of a buffer memory 140 that stores intermediate data generated in the processing process, and control of the vehicle 100 (e.g., motion-control logic, sensor-fusion routines, or low-level hardware drivers, etc.). The system memory 160 loads and stores the application by the request message of the controller 118, and the controller 118 may execute the application stored in the system memory 160.

Specifically, the application may be software that dynamically stores intermediate data generated from a plurality of sensor data input to a particular processor of the controller 118 and transmitted to another processor in the buffer memory 140. In addition, the application may be software that establishes a path (or an estimated path or a driving path) of the vehicle 100 using an environment around the vehicle 100 recognized based on sensor data processed from the processors and controls the vehicle 100 based on the path (e.g., lane following, obstacle avoidance, or intersection handling, etc.).

The plurality of sensor data may include, for example, a plurality of image data generated for each multi-camera. As another example, the plurality of sensor data may include image data of the camera 102a and heterogeneous data of a heterogeneous sensor (e.g., a radar sensor, a lidar sensor, or an ultrasonic sensor, etc.). The plurality of sensor data is not limited to the above-described example and may include sensor data obtained from at least one of different homogeneous sensors and heterogeneous sensors (e.g., multi-radar fusion, camera–IMU fusion, or radar–lidar fusion, etc.).

The controller 118 may perform overall control of the vehicle 100. The controller 118 may be configured to execute applications and instructions stored in the memory 116.

The controller 118 may generate signals related to control for components of the vehicle 100 in response to control requests in manual driving and autonomous driving. In the present disclosure, the controller 118 is exemplified as an autonomous driving controller, and the autonomous driving controller may be mounted on, for example, an Electric Control Unit (ECU). Although the present disclosure illustrates an autonomous driving controller, the vehicle 100 may include various controllers. For example, a Motor Control Unit (MCU), a Transmission Control Unit (TCU), a Battery Management System (BMS), an autonomous driving controller, an air conditioning controller, an Electric Drive Control Unit (EDCU), or a vehicle communication network controller, and the like may be provided in the vehicle 100 (e.g., distributed domain controllers, zonal controllers, or consolidated vehicle computers, etc.).

The controller 118 may be implemented, for example, as a System on Chip (SoC). The controller 118 includes components (or modules) having various functions on a single chip, and may include the processor 130, the buffer memory 140, and a chip memory bus 150 used to communicate data between the processor 130 and the buffer memory 140, as illustrated in FIG. 3. The controller 118 includes, in addition to the components described above, timing generators, external interfaces, converters, and the like, and these components may be coupled to the chip memory bus 150. The timing generator includes, for example, a timing generator phase-locked loop (PLL), and the external interface may include at least one of, for example, PCIe, or Universal Serial Bus (USB). The converter may include, for example, an analog-to-digital converter or a digital-to-analog converter (e.g., high-speed ADCs, sigma-delta DACs, or mixed-signal converters, etc.).

The components described above are exemplary, and the controller 118 may further include other modules. Further, the above-described components of the controller 118 may be mounted on a single chip. In the present disclosure, for convenience of description, the processor 130, the buffer memory 140, and the chip memory bus 150 are described.

The controller 118 may include a first processor 132 and a second processor 134 to execute preprocessing, perception processing, and control processing, and perform the above-described processing (e.g., sensor decoding, feature extraction, or trajectory computation, etc.).

The first processor 132 may include, for example, a neural processing device, and the neural processing device may be a neural processing unit (NPU). The first processor 132 may, for example, execute at least some parts of detailed modules of a learning model related to at least object recognition (e.g., bounding-box detection, lane-line segmentation, or depth inference, etc.). The first processor 132 may include a first processing unit 132a and a first cache memory 132b. The first processing unit 132a may execute a detailed module stored in the system memory 160. The first cache memory 132b may receive and temporarily store data used in the first processing unit 132a from the buffer memory 140 or may temporarily store the processed data in order to transmit the data processed in the first processing units 132a to the system memory 160.

The learning model may be configured as a deep learning model that receives a plurality of sensor data to infer perception data of an object. For example, the deep learning model may include a network model that performs object detection, semantic segmentation, depth estimation, and the like (e.g., YOLO-type detectors, encoder–decoder architectures, or transformer-based perception models, etc.). The learning model may be configured to have a plurality of detailed modules. The detailed modules may include, for example, a convolution generator for encoder or feature extraction, a matrix operator for generation of vector maps, various generators and operators used in decoders (e.g., up sampling blocks, attention blocks, or fusion blocks, etc.), and the like. In this disclosure, the detailed module may be referred to as a detailed component or a detailed modular.

The second processor 134 includes, for example, a central processing device, and the central processing device may be a central processing unit (CPU). The second processor 134 may include a second processing unit 134a and a second cache memory 134b. The second processing unit 134a may execute parts of detailed modules of a learning model stored in the system memory 160, preprocessing, intermediate processing, or control processing related to the learning model (e.g., temporal filtering, object tracking, or cost-map generation, etc.), and the like. The second cache memory 134b may receive and temporarily store data used in the second processing unit 134a from the buffer memory 140 or may temporarily store the processed data in order to transmit the data processed in the second processing units 134a to the system memory 160.

The pre-processing may include, for example, noise removal, filtering, or clustering of the sensor data (e.g., denoising radar points, normalizing image frames, or merging adjacent LiDAR points, etc.). The control process may estimate a path based on the perception data inferred from the learning model and generate a control command based on the estimated path. The control command includes at least one of a longitudinal control and a lateral control and may be generated as a control signal of the actuator 114 (e.g., throttle command, brake torque, or steering angle request, etc.). The control process may be performed, for example, using a learning model for path estimation and generation of control commands.

The second processor may further comprise, in addition to the central processing device, a graphics processing device or a digital signal processing device. In the present disclosure, the graphics processing device and the digital signal processing device may be described as a third processor 136 and a fourth processor 138 in FIG. 3, to distinguish them from the central processing device.

The third processor 136 corresponding to the graphics processing device may include a Graphical Processing Unit (GPU) that supports execution of a learning model. The third processor 136 may include a third processing unit 136a and a third cache memory 136b. The third processing unit 136a may execute a part of detailed module of a learning model stored in the system memory 160 (e.g., batch-parallel computations, tensor operations, or large-matrix multiplications, etc.). The third cache memory 136b may receive and temporarily store data used in the third processing unit 136a from the buffer memory 140 or may temporarily store the processed data in order to transmit the data processed in the third processing unit 136a to the system memory 160.

The fourth processor 138 corresponding to the digital signal processing device may comprise, for example, a Digital Signal Processor (DSP) for postprocessing of the perception data (e.g., smoothing, encoding, or formatting of perception results, etc.). The fourth processor 138 may include a fourth processing unit 138a and a fourth cache memory 138b. The fourth processing unit 138a may execute postprocessing. The fourth cache memory 138b may receive and temporarily store data used in the fourth processing unit 138a from the buffer memory 140 or may temporarily store the processed data in order to transmit the data processed in the fourth processing unit 138a to the system memory 160. The postprocessing may process the perception data generated by the perception processing into a suitable format for the control processing or process the perception data into a format suitable for transmission for the control processing. The postprocessing may include, for example, encoding, compressing, or packetizing in a predetermined manner, etc., of perception data.

The buffer memory 140 may store a plurality of preceding data processed by the first processor 132 and stored in the system memory 160 according to a predetermined criterion and load the preceding data into the second processor according to a request of the second processor (e.g., round-robin loading, priority-based loading, or size-based loading, etc.). The buffer memory 140 may transmit to the system memory 160, the preceding data that has been processed by the second processor, that is, the task data. The second processor is a central processing device, a graphics processing device, or a digital signal processing device, and for convenience of description in the present disclosure, the second processor 134 is exemplified as a central processing device.

The buffer memory 140 may include a buffer cache memory 142 and a buffer controller 144. The buffer cache memory 142 may receive a plurality of preceding data from the system memory 160 and temporarily store the preceding data. The buffer cache memory 142 may have a higher bandwidth than the system memory 160 configured with DRAM, while having less storage capacity than the system memory 160 (e.g., SRAM-based cache, multi-bank scratchpad, or high-speed on-chip buffer, etc.). In other words, the system memory 160 may have a lower access speed than the buffer cache memory 142, but a larger storage capacity than the buffer cache memory 142.

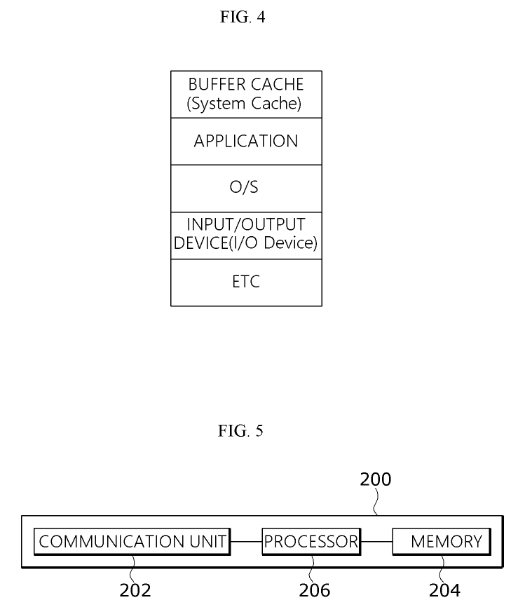

As illustrated in FIG. 4, most components of the processor, applications, buffer cache memory 142, and related modules may be mapped to the address space of system memory 160. FIG. 4 is shows an example of a memory map of a system memory. Software control may be operated by manipulating registers of mapped addresses or performing read/write operations of data in the address space. As shown in FIG. 4, the buffer cache memory 142 is mapped to an address space corresponding to a buffer cache, so that software control logic may read or write related data (e.g., intermediate feature maps, object vectors, or task identifiers, etc.).

The buffer controller 144 may dynamically manage the storage of preceding data received from the system memory 160 and the transfer of task data to the system memory 160 (e.g., batching transfers, prioritizing larger data blocks, or reordering tasks based on load, etc.).

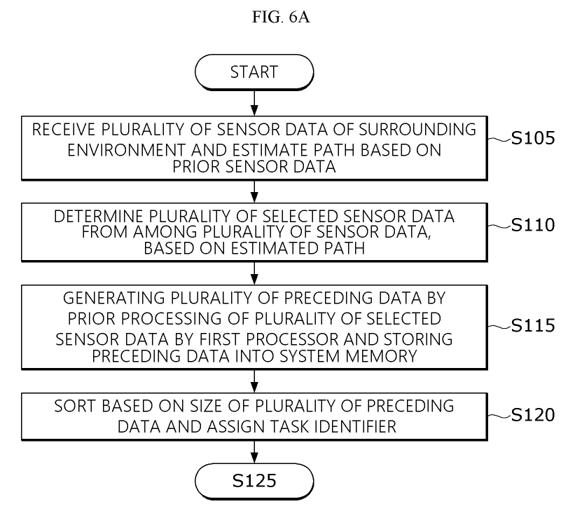

FIG. 5 shows an example of modules that configures a server according to the present disclosure.

The server 200 may transmit response data according to a request of the vehicle 100 to the vehicle 100, and also transmit an application embedded in the vehicle 100 and information for supporting vehicle driving to the vehicle 100 (e.g., HD-map updates, model updates, or driving-assistance information, etc.). The server 200 may include a communication unit 202, a memory 204, and a processor 206.

The communication unit 202 may transmit and receive data to and from an external device, support mutual communication with the vehicle 100 in the present disclosure, and exchange data with the vehicle 100 (e.g., driving logs, control requests, or diagnostic information, etc.).

The memory 204 may store a program and various data for operating the server 200 and load the program or read and write the data at the request of the processor 206. The memory 204 may hold and manage a program for processing a request of the vehicle 100, an application embedded in the vehicle 100, and information for driving assistance (e.g., firmware, perception models, or service policies, etc.).

The processor 206 may perform overall control of the server 200. The server 200 may be configured to execute programs and instructions stored in the memory 204. The processor 206 may execute the program to process and respond to the user's request transmitted from the vehicle 100 (e.g., route planning, remote diagnostics, or remote-control authorization, etc.).

In the present disclosure, the processor 206 is illustrated as being configured as a single processing module. In another example, the processor 206 may be distributed into a plurality of processing modules, and the processing described above may be executed by a distributed processing model (e.g., edge servers, cloud nodes, or load-balanced clusters, etc.).

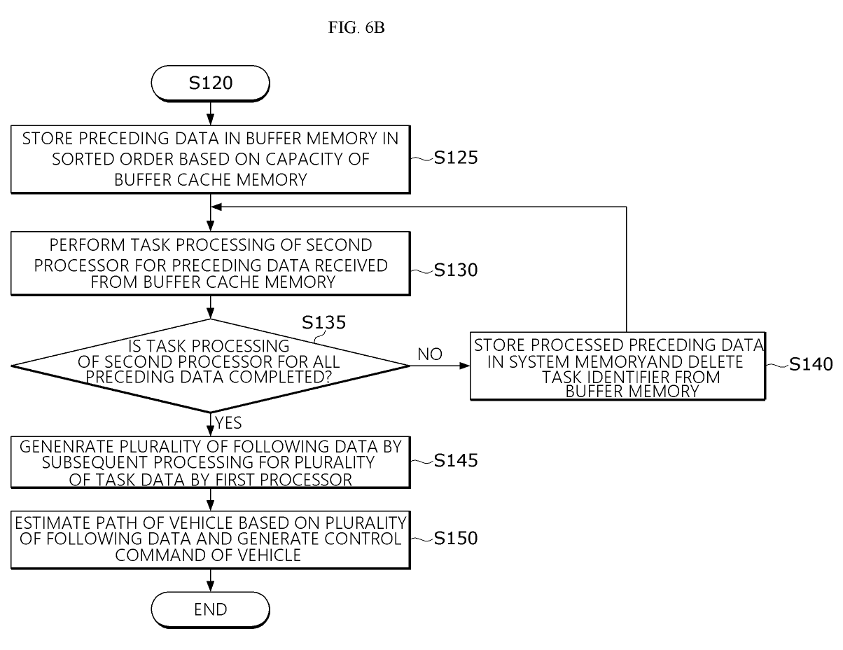

Hereinafter, a method for controlling a buffer memory in a controller according to another example of the present disclosure will be described in detail with reference to FIGS. 2, 3, 6A and 6B. FIGS. 6A and 6B are exemplary flowcharts of a method for controlling a buffer memory according to another example of the present disclosure. The second processor is a central processing device, a graphics processing device, or a digital signal processing device, and the second processor 134 is exemplified as a central processing device for convenience of description below. Unless technically contradictory, the following may be applied to an example of the second processor configured with a graphics processing device or a digital signal processing device.

In addition, in the present disclosure, it is described that the data processed by the processor 130 is sensor data for detecting the surrounding environment. The data is not limited to sensor data and may be various kinds of data processed by a plurality of processors of the controller 118 (e.g., fused BEV features, compressed depth maps, or processed radar point sets, etc.). Unless technically contradictory, the following may similarly apply to the processing of processors suitable for various kinds of data and dynamic management via buffer memory.

Referring to S105 of FIG. 6A, the controller 118 of the vehicle 100 may receive a plurality of sensor data from the sensor unit 102 that detects the surrounding environment, and estimate a path based on prior sensor data (e.g., previous frames, previous radar sweeps, or previously computed trajectories, etc.).

The plurality of sensor data may include, for example, a plurality of image data generated for each multi-camera. In another example, the plurality of sensor data may include image data of the camera 102a and heterogeneous data of a heterogeneous sensor. The heterogeneous sensor may be, for example, a radar sensor, or a lidar sensor.

The prior sensor data may be sensor data acquired by the sensor unit 102 before the sensor data related to S105. The estimated path may be generated by a series of processes on prior sensor data, as described in FIG. 3. As another example, the estimated path may be predicted based on a control signal output to the preceding control process described in FIG. 3, a request signal of steering received from the operation unit 104, or an on signal of a direction indicator, such as a direction indicator light, received from the operation unit 104, and the like (e.g., right-turn indicator, lane-change request, or steering-wheel rotation, etc.).

Referring to S110 of FIG. 6A, the controller 118 may determine, based on the estimated path, a plurality of selected sensor data from among the plurality of sensor data. The determination of the selected sensor data may be performed, for example, by the first processor 132. The plurality of selected sensor data may be stored, for example, in the system memory 160.

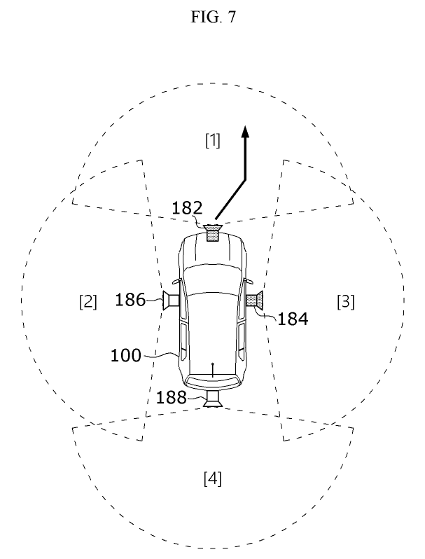

As illustrated in FIG. 7, when the estimated path is a right turn followed by straight movement (see an arrow in FIG. 7) or a right cut-in for entering the right lane, sensor data (or image data) related to a front camera 182 and a right camera 184 among multi-cameras 182 to 188 may be determined as selected sensor data (e.g., forward-facing images or right-side lane images, etc.). FIG. 7 is shows an example of sensor data obtained by a plurality of sensors. In the case of right turn followed by straight movement, the environment acquired by the front camera 182 and the right camera 184 may be more important than that of a left camera 186 and a rear camera 188.

Referring to S115 of FIG. 6A, the first processor 132 of the controller 118 may perform a prior processing on the plurality of selected sensor data to generate a plurality of preceding data and store the plurality of preceding data in the system memory 160 (e.g., feature tensors, intermediate representations, or encoded spatial maps, etc.).

The first processor 132 may include, for example, a neural processing device, and the neural processing device may be an NPU. The prior processing of the first processor 132 may include, for example, executing at least some of the detailed modules of a learning model related to object recognition. The learning model may be a deep learning model that infers perception data of an object, as described above. Detailed modules of the learning model may include, for example, a convolution generator for encoder or feature extraction, a matrix operator for generation of vector maps, various generators and operators used in decoders, and related components.

The first processing unit 132a may load a detail module stored in the system memory 160, receive a plurality of selected sensor data stored in the system memory 160, and output a plurality of preceding data (e.g., intermediate data produced by prior processing of selected sensor data (e.g., feature maps or encoded representations) that precedes the task-processing stage).

Referring to S120 of FIG. 6A, the buffer controller 144 may sort the plurality of preceding data and assign a task identifier to the preceding data based on the size of the plurality of the preceding data transmitted from the system memory 160 (e.g., arranging larger feature maps first, grouping similar sizes, or prioritizing tasks based on computational cost, etc.).

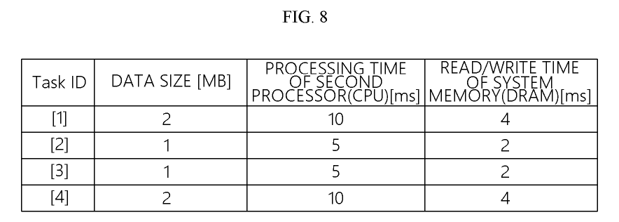

The buffer controller 144 may, for example, sort the sizes of the plurality of preceding data in descending order. As illustrated in FIG. 8, the buffer controller 144 may assign a task identifier (Task ID) to the aligned preceding data. FIG. 8 shows an example of a specification of task processing in a second processor. FIG. 8 is not illustrated by the selected sensor data in S110 but is illustrated by the preceding data based on the sensor data of the front camera 182, the right camera 184, the left camera 186, and the rear camera 188. As another example from the example of FIG. 8, the sort of the preceding data may be processed such that task identifiers (Task IDs) 1 and 4 having a large size are arranged higher than Task IDs 2 and 3.

The buffer controller 144 may store information related to the task data sorted with the task identifier in the buffer cache memory 142 (e.g., size tables, task metadata, or load-order information, etc.).

Referring to S125 of FIG. 6B, the buffer controller 144 may store the plurality of preceding data in the buffer cache memory 142 in a sorted order, based on the capacity of the buffer cache memory 142 (e.g., storing largest feature maps first, packing remaining capacity with smaller units, or replacing older entries, etc.).

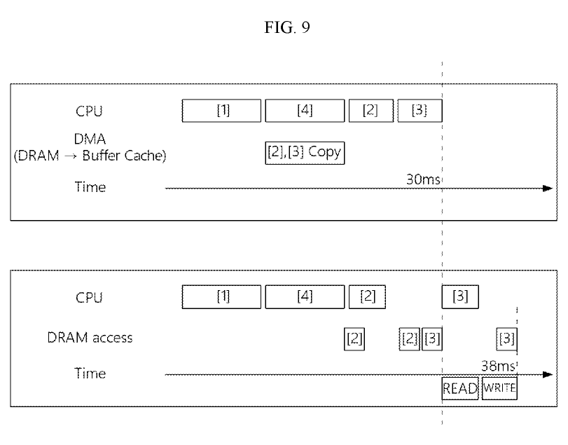

Specifically, the buffer controller 144 may store at least a portion of the plurality of preceding data in the buffer cache memory 142 in a sorted order, to match the capacity of the buffer cache memory 142. The sorted order may be determined in descending order of the size of the preceding data. As illustrated in the upper diagrams of FIGS. 8 and 9, when the buffer cache memory 142 has a storage capacity of 4M and the sorted order is the task identifiers 1, 4, 2, 3, the buffer controller 144 may store a plurality of preceding data corresponding to the Task IDs 1 and 4 in the buffer cache memory 142 to match the storage capacity of the buffer cache memory 142 (e.g., combining IDs 1 and 4 if together they fit within 4M, etc.). FIG. 9 shows an example of data processing according to a combination of a buffer memory and a system memory and the use of the system memory alone.

Referring to S130 of FIG. 6B, the second processor 134 may perform task processing on the preceding data stored in the buffer cache memory 142 in a sorted order to generate task data (e.g., computing feature refinements, running decoder blocks, or performing downstream control estimation, etc.).

The second processor 134 includes a central processing device and may load some of the detailed modules of a learning model stored in the system memory 160 or intermediate processing software related to the learning model to perform task processing on the preceding data received from the buffer cache memory 142.

In addition, the second processor 134 may check, during task processing, whether subsequent preceding data is in the system memory 160. The buffer controller 144 may, in response to (or based on) the presence of the subsequent preceding data, based on the capacity of the buffer cache memory 142, store the subsequent preceding data in the buffer cache memory 142 in a sorted order (e.g., next-largest unused items, reduced-size blocks, or lower-priority entries, etc.).

As illustrated in the upper diagram of FIG. 9, while the second processor 134 sequentially performs task processing on the preceding data of the task identifiers 1, 4 received from the buffer cache memory 142, the buffer controller 144 may determine whether subsequent preceding data exists in the system memory 160. In response to (or based on) the presence of the preceding data of task identifiers 2, 3 corresponding to the subsequent preceding data, the buffer controller 144 may store, based on the capacity of the buffer cache memory 142, the preceding data of the task identifiers 2, 3 in a sorted order in the buffer cache memory 142. Specifically, when the preceding data of the task identifier 4 stored in the buffer cache memory 142 in a subordinate order is loaded and processed by the second processor 134, the preceding data of task identifiers 2 and 3 may be stored in the buffer cash memory 142 in a sorted order (e.g., filling freed space as soon as it becomes available, etc.).

Referring to S135 of FIG. 6B, the second processor 134 may determine whether the task processing for all the preceding data is completed.

As illustrated in the upper diagram of FIG. 9, after completing the task processing on the preceding data of the task identifiers 1 and 4, the second processor 134 may determine whether the task processing on all the preceding data is completed by requesting the buffer controller 144 to check whether the preceding data following the buffer cache memory 142 remains. When the subsequent preceding data remains, it may be determined that the task processing for all the preceding data is incomplete. Alternatively, when the subsequent preceding data is not in the buffer cache memory 142, it may be determined that the task processing for all the preceding data is completed.

Referring to S140 of FIG. 6B, the buffer controller 144 may store the task data in the system memory 160 and delete the task identifier associated with the task data based on the task processing for all the preceding data being incomplete. The second processor 134 may perform task processing on subsequent preceding data stored in the buffer cache memory 142 in a sorted order to generate task data, so as to execute substantially the same task processing as in S130 (e.g., applying the remaining decoder layers, computing post-processing filters, or generating control-related tensors, etc.).

Referring to S145 of FIG. 6B, the first processor 132 may execute a subsequent processing on the plurality of task data stored in the system memory 160 based on completion of the task processing on all of the plurality of preceding data, to generate a plurality of following data (e.g., fused BEV maps, object lists, or spatiotemporal scene representations, etc.).

The first processor 132 may receive a completion message of task processing from the second processor 134 and execute the subsequent processing. The subsequent processing may, for example, execute at least some of the detailed modules of the learning model related to object recognition, and specifically execute a different detailed module than the prior processing (e.g., a decoder stage, a feature-merging block, or a temporal-tracking unit, etc.).

Referring to S150 of FIG. 6B, the controller 118, e.g., the first processor 132, may generate an estimated path of the vehicle 100 based on the plurality of following data, and generate a control command for operation, e.g., driving, of the vehicle 100, based on the estimated path (e.g., issuing a turning request, lane-keeping control, or collision-avoidance command, etc.).

With reference to FIGS. 8 and 9, a combination between the buffer memory 140 and the system memory 160 of the controller 118 according to the present disclosure and a processing time according to the sole use of the system memory are compared. To calculate the total processing time, the size of the preceding data, the processing time of the second processor for the preceding data, and the read/write time of the system memory may be in accordance with the example of FIG. 8 (e.g., fixed feature-map sizes, predetermined CPU execution cycles, or estimated DRAM latency values, etc.).

The upper diagram of FIG. 9 shows the data processing time according to the combination between the buffer memory 140 and the system memory 160 of the controller 118 according to the present disclosure, and the bottom diagram of FIG. 9 shows the data processing time according to the combination of the controller and the system memory without the buffer memory. Direct Memory Access (DMA) indicated in the upper diagram of FIG. 9 may mean accessing a memory and executing a read/write operation without occupying the second processor (CPU). In the present disclosure, DMA may be an operation in which the preceding data is transferred from the system memory 160 to the buffer cache memory 142 (e.g., background transfer of large feature blocks, burst read cycles, or queued DMA-copy commands, etc.).

As may be seen in FIG. 9, according to the example of FIG. 8, the total data processing time according to the present disclosure may be shortened by 8 ms compared to processing without using a buffer memory. According to the present disclosure, resource efficiency and processing rate may be improved by dynamic memory management using a system cache according to a buffer memory (e.g., reducing CPU stalls, minimizing DRAM access bottlenecks, or increasing the concurrency of perception pipelines, etc.).

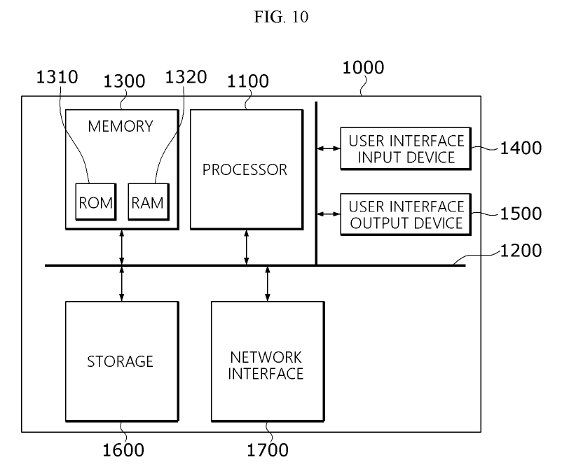

FIG. 10 shows an example computing system (e.g., a computing device of a vehicle or any other apparatus). One or more controllers, processors, etc. described herein, such as one or more components of the vehicle 100, one or more components of the server 200, one or more components of another vehicle 300, and any other components and devices disclosed herein, may be implemented by or in the computing system as shown in FIG. 10.

A computing system 1000 may include at least one processor 1100, memory 1300, a user interface input device 1400, a user interface output device 1500, a storage 1600, and a network interface 1700, which are connected with each other via a bus 1200. The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to the present disclosure , there is provided a method for controlling a buffer memory using a controller including a first processor, a second processor and a buffer memory, and a system memory, the method for controlling a buffer memory comprising: aligning, based on a size of a plurality of preceding data generated by processing of the first processor on a plurality of sensor data in which a surrounding environment is detected, the plurality of preceding data; storing, based on a capacity of the buffer memory, the plurality of preceding data in an alignment order in the buffer memory; performing, by the second processor, task processing on the preceding data stored in the buffer memory in the alignment order to generate task data; storing, based on the incomplete processing of all of the plurality of preceding data, the task data in the system memory; generating, by the first processor, based on the complete processing on all of the plurality of preceding data, following data based on the task data; and generating, by the controller, based on the following data, a control command for control of a device.

In some implementations, the first processor may be a neural processing device, and the second processor is a central processing unit, a graphics processing unit, or a digital signal processor.

In some implementations, the plurality of preceding data may be stored in the system memory, and wherein the aligning the preceding data comprises aligning the plurality of preceding data transmitted from the system memory.

In some implementations, the alignment order may be determined in descending order of the size of the preceding data.

In some implementations, the storing the plurality of preceding data in the buffer memory may comprise storing at least a portion of the plurality of preceding data in the alignment order in the buffer memory to match a capacity of the buffer memory. Also, the generating task data may further comprise storing, based on the capacity of the buffer memory, following preceding data in the alignment order in the buffer memory in response to the presence of the following preceding data.

In some implementations, the aligning the plurality of preceding data may further comprise assigning a task identifier to the preceding data.

In some implementations, the method may further comprise deleting the task identifier associated with the task data based on the incomplete processing of all the plurality of preceding data.

In some implementations, the method may further comprise, before aligning the plurality of preceding data, determining a plurality of selected sensor data from among the plurality of sensor data by considering an estimated path of the device based on prior sensor data that detects the surrounding environment. Also, the plurality of sensor data may comprise the plurality of selected sensor data.

In some implementations, the processing of the first processor to generate the preceding data may comprise executing some of the detailed modules belonging to a learning model in the first processor to process the sensor data.

In some implementations, the controller may be implemented as a System on Chip (SoC) on which the first processor, the second processor, and the buffer memory are mounted, and the system memory may be configured as a volatile memory.

According to another example of the present disclosure, there is provided a vehicle, comprising: a plurality of sensors that detect a surrounding environment and acquire a plurality of sensor data; a memory storing at least one instruction and including a system memory; and a controller that executes the at least one instruction stored in the memory and comprises a first processor that performs processing related to control of the vehicle, a second processor that performs the processing, and a buffer memory that is managed as a buffer controller. The controller is configured to: align, based on a size of a plurality of preceding data generated by processing of the first processor on a plurality of sensor data, the plurality of preceding data; store, based on a capacity of the buffer memory, the plurality of preceding data in an alignment order in the buffer memory; perform, by the second processor, task processing on the preceding data stored in the buffer memory in the alignment order to generate task data; store, based on the incomplete processing of all of the plurality of preceding data, the task data in the system memory; generate, by the first processor, based on the complete processing on all of the plurality of preceding data, following data based on the task data; and generate, based on the following data, a control command for control of a device.

Further, resource efficiency may be further increased by not processing unnecessary sensor data based on the estimated path in the autonomous driving system.

According to the present disclosure, it is possible to provide a method for managing a buffer memory and a vehicle that improve resource efficiency and processing rate by dynamic memory management using system cache.

The effects obtainable in the present disclosure are not limited to the effects mentioned above, and other effects not mentioned will be clearly understood by a person skilled in the art from the following description.

While the exemplary methods of the present disclosure described above are represented as a series of operations for clarity of description, it is not intended to limit the order in which the steps are performed, and the steps may be performed simultaneously or in different order as necessary. To implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more.

In addition, various examples of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by a vehicle, the method comprising:
obtaining, via a sensor of the vehicle, sensor data associated with a surrounding environment of the vehicle;
storing, into a system memory of the vehicle, the sensor data;
generating, based on the sensor data, preceding data;
sorting portions of the preceding data based on sizes of the respective portions of the preceding data;
storing, based on a capacity of a buffer memory, the portions of the preceding data in an order of the sorted portions in the buffer memory, wherein the buffer memory has a higher access speed and a smaller storage capacity than the system memory;
performing task processing on the portions stored in the buffer memory in the order of the sorted portions to generate task data;
storing, based on incomplete processing of all the portions, the task data in the system memory;
generating, based on the task data and complete processing of all the portions, control data; and
outputting, based on the control data, a control command; and
controlling, based on the control command, a control operation of the vehicle.

2. The method of claim 1, wherein the generating of the preceding data and the control data is performed by a neural processing device, and wherein the task processing is performed by at least one of a central processing unit, a graphics processing unit, or a digital signal processor.

3. The method of claim 1, wherein the portions of the preceding data are generated in the system memory before being sorted and stored in the buffer memory.

4. The method of claim 1, wherein the order of the sorted portions is determined in descending order of the sizes of the respective portions.

5. The method of claim 1,
wherein the storing of the portions of the preceding data in the buffer memory comprises storing at least a portion of the portions in the order in the buffer memory to match the capacity of the buffer memory, and
wherein the generating of the task data comprises storing, based on the capacity of the buffer memory, additional preceding data in the order in the buffer memory based on presence of the additional preceding data.

6. The method of claim 1, wherein the sorting of the portions of the preceding data comprises assigning a task identifier to each portion of the preceding data.

7. A vehicle comprising:
a sensor configured to obtain sensor data indicating a surrounding environment of the vehicle;
a main memory configured to store the sensor data;
a local memory configured to provide a higher access speed and a smaller storage capacity than the main memory; and
a processor circuit configured to cause the vehicle to:
determine a path of the vehicle based on the sensor data,
select, from the sensor data, sensor data associated with the path,
perform a first-stage processing on the selected sensor data to generate preceding data and store the preceding data in the main memory,
sort portions of the preceding data based on sizes of the respective portions of the preceding data,
store, based on a capacity of the local memory, a portion of the sorted portions into the local memory,
perform a second-stage processing on the portion stored in the local memory,
determine, during the second-stage processing, whether additional portions of the preceding data remain in the main memory,
based on additional portions remaining in the main memory, load the additional portions from the main memory into the local memory in an order of the sorted portions,
perform a third-stage processing on task data generated by the second-stage processing to generate control data,
output a signal associated with the control data, and
control, based on the signal, autonomous driving of the vehicle.

8. The vehicle of claim 7, wherein the portions of the preceding data are sorted in descending order of sizes of the respective portions of the preceding data.

9. The vehicle of claim 7, wherein, during the sorting of the portions of the preceding data, the processor circuit assigns a first task identifier to a first portion of the portions of the preceding data, and wherein, after the second-stage processing on the first portion is completed, the processor circuit deletes the first task identifier assigned to the first portion.

10. The vehicle of claim 7, wherein the processor circuit and the local memory are provided within a System-on-Chip (SoC), and the main memory comprises a volatile memory.

11. A vehicle comprising:
a plurality of sensors configured to obtain sensor data associated with a surrounding environment of the vehicle;
a system memory configured to store the sensor data;
a buffer memory configured to have a higher access speed and a smaller storage capacity than the system memory; and
a processor;
wherein the system memory stores at least one instruction that, when executed by the processor, is configured to cause the vehicle to:
generate, based on the sensor data, preceding data,
sort portions of the preceding data based on sizes of the respective portions of the preceding data,
store, based on a capacity of the buffer memory, the portions of the preceding data in an order of the sorted portions in the buffer memory,
perform task processing on the portions stored in the buffer memory in the order of the sorted portions to generate task data,
store, based on incomplete processing of all the portions, the task data in the system memory,
generate, based on the task data and complete processing of all the portions, control data,
output, based on the control data, a control command, and
control, based on the control command, a control operation of the vehicle.

12. The vehicle of claim 11, wherein the generation of the preceding data and the generation of the control data are performed by a neural processing device, and wherein the task processing is performed by at least one of a central processing unit, a graphics processing unit, or a digital signal processor.

13. The vehicle of claim 11, wherein the portions of the preceding data are generated in the system memory before being sorted and stored in the buffer memory.

14. The vehicle of claim 11, wherein the order of the sorted portions is determined in descending order of the sizes of the respective portions.

15. The vehicle of claim 11, wherein, during the storing of the portions of the preceding data in the buffer memory, at least a portion of the portions of the preceding data is stored in the order in the buffer memory to match the capacity of the buffer memory, and
wherein, during the performing of the task processing, additional portions of the preceding data are stored in the order in the buffer memory based on presence of the additional portions of the preceding data.

16. The vehicle of claim 11, wherein, during the sorting of the portions of the preceding data, a task identifier is assigned to each portion of the preceding data.

17. The vehicle of claim 16, wherein, after task processing on a portion of the preceding data is completed, a task identifier assigned to the portion is deleted.

18. The vehicle of claim 11, wherein the at least one instruction, when executed by the processor, is configured to cause the vehicle to:
select, based on prior sensor data, pieces of sensor data from among a plurality of pieces of sensor data, wherein the selected pieces of sensor data correspond to an estimated path of the vehicle, and
generate, based on the selected pieces of sensor data, the preceding data.

19. The vehicle of claim 11, wherein the at least one instruction, when executed by the processor, is configured to cause the vehicle to execute, based on the sensor data, at least one layer of a neural-network-based learning model to generate the preceding data.

20. The vehicle of claim 11, wherein the processor and the buffer memory are provided within a System on Chip (SoC), and wherein the system memory comprises a volatile memory.
